(19) United States
(12) Patent Application Publication
(10) Pub. No.: US 2007/0285241 A1
(43) Pub. Date: Dec. 13, 2007

(54) Multi-Tag Tracking Systems and Methods

(75) Inventors: Allan R. Griebenow, Plano, TX (US); James A. Ferguson, Plano, TX (US); Joseph R. Flicek, New York, NY (US); Benjamin D. Donohue, McKinney, TX (US); Michael H. Beber, Plano, TX (US); Rajinder Bridgelall, Plano, TX (US)

Correspondence Address: BAKER BOTTS L.L.P., 2001 ROSS AVENUE, SUITE 600, DALLAS, TX, 75201-2980, US

(73) Assignee: Axcess International Inc., Carrollton, TX (US)

(21) Appl. No.: 11/688,681

(22) Filed: Mar. 20, 2007

Related U.S. Application Data
(60) Provisional application No. 60/784,211, filed on Mar. 20, 2006.

(51) Int. Cl. G08B 13/14

(52) U.S. Cl. 340/572.1

(57) ABSTRACT

In certain embodiments, a tag tracking system includes one or more asset radio frequency identification (RFID) tags each associated with an asset, one or more asset aggregation RFID tags each associated with an aggregation of assets, and one or more personnel RFID tags each associated with a person. The system also includes one or more receivers operable to receive tag information from the one or more asset tags, the one or more asset aggregation tags, and the one or more personnel tags. The system also includes control software operable to receive at least a portion of the tag information from the one or more receivers and to integrate the received tag information to track the one or more asset tags, one or more asset aggregation tags, and one or more personnel tags in association with one another.

### RELATED APPLICATION

This application claims the benefit under 35 U.S.C. § 119(e) of U.S. Provisional Application No. 60/784,211, entitled “Multi-Tag Tracking Systems and Methods,” filed on Mar. 20, 2006.

### TECHNICAL FIELD

This invention relates in general to radio frequency identification (RFID) systems, and more particularly to a multi-RFID tag tracking systems and methods.

### BACKGROUND

The management and tracking of personnel, assets, and other objects is required in a wide variety of environments and is often cumbersome, labor intensive, and expensive. Radio receivers and transmitters have been used for many years to identify personnel and objects in such environments. For example, many systems are known for attaching radio tags to items, such as personnel, assets, and automobiles. When automobiles equipped with radio tags enter a certain area, such as a toll booth area, the automobiles are automatically identified. The appropriate tolls are deducted from corresponding accounts, thereby eliminating the need for drivers to stop and make payments at toll booths. When radio tags are placed on personnel, they can be automatically identified and checked for authorized entry to a facility in a security application called access control. Assets which are tagged can be identified and tracked as they move throughout a facility for the purposes of automatically locating them. They can also be automatically counted therefore providing inventory control. They can also be protected as when an asset approaches an exit doorway the system can automatically determine if the asset is authorized to be removed from the facility. Tagged vehicles, assets, and personnel can be linked logically in the system to enable greater visibility and control.

Radio frequency identification (RFID) systems generally use a fixed position transmitter capable of reading remote, portable tags attached to personnel, assets, or other objects. Because of power consumption concerns and the life span of the tag, the radio tag often operates only after receiving a wake-up signal, often called semi-active operation. The wake-up signal is generated by a powered device called an activator which transmits the desired signal through a specially designed antenna based upon the physical properties of the area. Activation causes the tag to leave a low power state and enter an active state. The activation transmitter produces the wake-up signal, and an antenna transmits the wake-up signal to a particular area. Tags receiving the wake-up signal then wake-up and transmit a message to an associated receiver. This message may include an ID associated with the tag so that the location of the tag can be identified and tracked.

Although semi-active radio tags are common, many applications alternatively use passive radio tags. Passive tags are tags that do not contain a battery. Instead, power for the tag is supplied by the tag reader (radio waves from the reader cause a magnetic field to be formed around the antenna of the tag, and the field is used to energize the circuits in the tag). One particular application of passive radio tags is in association with the EPCglobal standard. This standard pairs the use of RFID systems with electronic product codes (EPCs) for management of high volume consumer package goods. This standard is effective at automatically identifying pallets, cartons, and individual items as they enter a warehouse facility via an entry/exit door portal.

### SUMMARY

According to the present invention, disadvantages and problems associated with previous RFID tag systems and methods may be reduced or eliminated.

In certain embodiments, a tag tracking system includes one or more asset radio frequency identification (RFID) tags each associated with an asset, one or more asset aggregation RFID tags each associated with an aggregation of assets, and one or more personnel RFID tags each associated with a person. The system also includes one or more receivers operable to receive tag information from the one or more asset tags, the one or more asset aggregation tags, and the one or more personnel tags. The system also includes control software operable to receive at least a portion of the tag information from the one or more receivers and to integrate the received tag information to track the one or more asset tags, one or more asset aggregation tags, and one or more personnel tags in association with one another.

In certain embodiments, an asset aggregation tag for tracking one or more asset tags includes a power source. The asset aggregation tag further includes one or more processing units operable to transition to a tag reader state to: (1) transmit a query to one or more asset tags each having an associated sensor, the query requesting a sensor condition of the sensor of the asset tag; (2) receive, from each of the one or more asset tags, tag information comprising a sensor condition responsive to the query; and (3) transmit an indication of the sensor condition of at least one of the asset tags.

Particular embodiments of the present invention may provide one or more technical advantages. Particular embodiments of the present invention provide an integrated system that includes one or more asset tags, one or more asset aggregation tags, one or more personnel tags, control sensors (e.g., temperature sensors) and media streams (e.g., video and/or audio) that permits the automatic, independent and substantially real-time assessment of physical assets and personnel (along with desired control sensors and media streams). Different types of assets and/or personnel may be tagged with active or passive tags and linked together to provide for monitoring and control of the assets and/or personnel as a collective unit. Passive tags may be used on individual assets when a large number of such assets are being tracked, and aggregations of these individual assets (such as a box containing a number of the assets and a carton containing a number of these boxes) may be tagged with active tags (to more precisely track their location). Personnel may be tagged with active tags in particular embodiments to more precisely track their location.

Such embodiments may also provide validation in real time or as a matter of historical record in period transaction logs. This allows for product, data, and personnel tracking from individual product, individual personnel, and data unit levels to any number of aggregated product, personnel, and data units groups and provides a way to effectively and efficiently manage and control business or manufacturing activity. The present invention may also provide substantially real-time monitoring, viewing, recording, and storage and may provide standard interfaces to other enterprise software systems for messaging and relaying (in real time and/or at later times) information useful for improved management systems.

Certain embodiments of the present invention may provide one or more of the following benefits: substantially real-time knowledge of system and components; confirmed validation of elements in the system at a later time; reduced risk of loss or missing elements; an understanding of level of loss of elements at all times; integration and recording of personnel, assets and conditions; the ability to provide reporting to meet Sarbanes-Oxley certification requirements; improved business process flow and control; and/or real time intervention when alarms are issued.

Certain embodiments of the present invention may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

For a more complete understanding of the present invention and its advantages, reference is made to the following descriptions, taken in conjunction with the accompanying drawings, in which:

FIG. 1 illustrates an example multi-tag tracking system, according to certain embodiments of the present invention;

FIG. 2 illustrates an example tag association table that may be stored in a database of the system;

FIGS. 3A-3B illustrates an example display that may be generated by control software as part of the graphical user interface of the control software;

FIG. 4 illustrates an example method for multi-tag tracking, according to certain embodiments of the present invention; and

FIG. 5 illustrates an example system in which asset aggregation tags are operable to receive and process tag information from asset tags, and to report this tag information (and/or conclusions determined from this tag information) to one or more receivers.

### DESCRIPTION OF EXAMPLE EMBODIMENTS

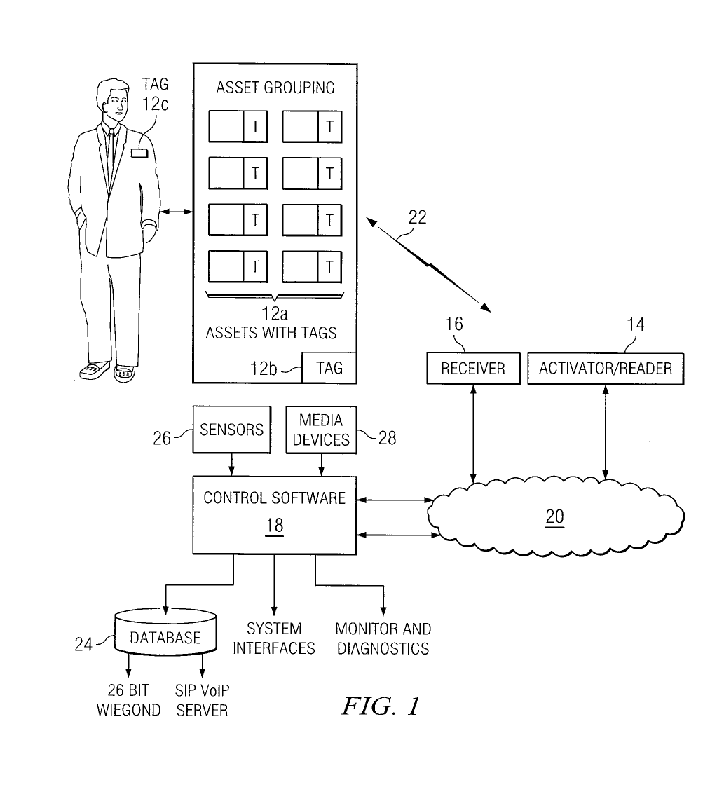

FIG. 1 illustrates an example multi-tag tracking system 10, according to certain embodiments of the present invention. Although a particular embodiment is illustrated and primarily described with respect to FIG. 1, the present invention contemplates any suitable embodiment of system 10.

System 10 includes a number of RFID tags 12 for monitoring one or more assets and/or personnel. The assets being monitored may include any suitable types of assets. Example assets include one or more products, one or more vehicles, one or more cartons, one or more pallets, or any other suitable types of assets. Personnel typically include persons, such as employees of a company or one or more guests of the employee. System 10 may also include one or more activators 14 and one or more receivers 16, which may be coupled to control software 18 via a network 20. In general, certain embodiments allow information for monitoring assets and/or personnel to be gathered from tags 12 by receiver 16, and to be stored or otherwise processed by control software 18.

System 10 may include a number of different types of tags 12. For example, system 10 may include one or more asset tags 12a, one or more asset aggregation tags 12b, and one or more personnel tags 12c (referred to collectively as tags 12). Each of asset tags 12a may be associated with one or more corresponding assets. Each asset aggregation tag 12b may be associated with an aggregation of asset tags 12. Each personnel tag 12c may be associated with a corresponding person.

As just one example of the use of the different types of tags 12, a box may include a number of individual assets (e.g., products). Each of the individual assets may be tagged with an asset tag 12a, the box may be tagged with an asset aggregation tag 12b (the aggregation of assets being the collection of individual assets in the box), and an employee responsible for transporting the box of assets may be tagged with a personnel tag 12c. As another example, a truck may be assigned for delivering a number of boxes to a destination. The trailer of the truck may be loaded with the boxes, each of which may be tagged with an asset tag 12a. The trailer of the truck (or some other portion of the truck) may be tagged with an asset aggregation tag 12b (the aggregation of assets being the boxes in the trailer of the truck). The driver of the truck may be tagged with a personnel tag 12c. Additional examples will be described below.

Each of asset tags 12a, asset aggregation tags 12b, and personnel tags 12c may be any suitable type of tag, such as an active tag, a semi-active tag, or a passive tag. In certain embodiments, each asset tag 12 is a passive tag and each asset aggregation tag 14 and personnel tag 16 is an active tag.

An active tag may include a tag that includes a local power source (e.g., a local battery) and that is operable to transmit a signal (e.g., a signal that includes tag information) on its own. For example, active tags may automatically transmit on a preprogrammed timed interval to assist in the location and tracking of escorts (e.g., personnel) and transport cases across broad areas within the designated area provided appropriate supporting network receivers are installed in appropriate locations.

A semi-active tag may include a tag that includes a local power source (e.g., a local battery). An semi-active tag may transmit when activated at a control point, in response to a wake-up signal from an activator for example. Unless otherwise indicated, for purposes of this description, the term active tag includes both an active tag as described above and a semi-active tag.

A passive tag may include a tag that does not contain a local power source (e.g., a battery). Passive tags typically operate using backscattering. For example, power for the tag is supplied by a tag reader (e.g., radio waves from the reader cause a magnetic field to be formed around the antenna of the tag, and the magnetic field is used to energize the circuits in the tag to transmit tag information). One type of passive tag that may be used is an EPC™ passive tag that meets the EPCglobal Generation 2 standard. This EPCglobal standard is expected to be used as a base platform upon which RFID readers and tags and future improvements can be built, ensuring complete interoperability and setting minimum operational expectations for various components in the EPCglobal network, including the various necessary hardware components and software components.

Different types of assets and/or personnel may be tagged with active or passive tags 12 and, as will be described in more detail below, linked together to provide for monitoring and control of the assets and/or personnel as a collective unit. Passive tags 12 may be used on individual assets when a large number of such assets are being tracked, and aggregations of these individual assets (such as a box containing a number of the assets and a carton containing a number of these boxes) may be tagged with active tags 12 (to more precisely track their location). Personnel may be tagged with active tags 12 in particular embodiments to more precisely track their location.

In certain embodiments, personnel tags 12c may provide convenient, hands-free identification of personnel responsible for escorting assets for access control, people tracking, and resource management applications. When activated at a control point, personnel tag 12c identification data may be sent to a nearby receiver and forwarded to control software via the network for logging and future review. Typically, personnel tags 12c are attached to escort clothing or suspended via a neck lanyard which will suffice for hands-free activation. Further, personnel tags 12c may be personalized by affixing a standard poly vinyl chloride (PVC) identity card into a recess in the tag case.

System 10 may include one or more activators 14. Certain types of tags 12 may operate only after receiving a wake-up signal, which may be referred to as semi-active operation. Activators 14 may generate these wake-up signals. Each activator 14 may be a powered device operable to transmit the desired wake-up signal through a specially designed antenna based upon the physical properties of the area. Activation causes appropriate tags 12 to leave a low power state and enter an active state. An activation transmitter of the activator 14 produces the wake-up signal, and an antenna of the activator 14 transmits the wake-up signal to a particular area. Appropriate tags 12 receiving the wake-up signal then “wake up” and transmit tag information to an appropriate receiver (e.g., receiver 16). Among other information, the tag information may include a tag ID associated with the transmitting tag 12 so that the location of the tag 12 can be identified and tracked. System 10 may include any suitable number of activators 14. In certain embodiments one or more activators 14 of system 10 are associated with one or more control points, such as a gate or a door. Additionally or alternatively, certain types of tags 12 may be operable to beacon tag information to one or more receivers 16 at a suitable interval (i.e., without a wake-up signal triggering tag 12 to send the tag information).

In certain embodiments, activator 14 is a stand-alone transmitter that connects directly to an application-specific antenna (e.g., a Plex Overhead Ceiling antenna) to provide a low frequency activation signal that awakens one or more of tags 12 in this design as they move through a designated control point. In one example, activator 14 writes its location ID to a tag 12, which is then re-transmitted by the tag 12, along with the unique ID of the tag 12, to provide the substantially precise location of the tag 12 at the time of activation. By adjusting the power output on activator 14, the activation area footprint can be expanded or reduced. Activator 14 may be configured with its own user-defined location ID via serial port (e.g., using a PC or terminal communications device) or manually via jumpers. The activator 14 unit may install easily and offer flexible coverage for perimeter access points (e.g., doors).

In certain embodiments, activators 14 may include one or more of the following: one or more passive tag hand readers; one or more semi-active tag activators; one or more passive tag activators; one or more ceiling antennas; and any other suitable types of activators. An Active Tag Plex-Overhead Ceiling Antenna (OCA) may provide a robust and reliable wake-up signal to such applications as asset tags 12a and personnel tags 12c moving through an interior control point. The OCA is a low-frequency activation antenna that connects directly to activator 14 to provide flexible coverage zones. In certain embodiments, an OCA generates an eleven foot to twelve foot wake-up signal footprint. A Passive Tag Reader/Antenna may be operable to activate and read passive tags. Passive tags may be activated and read by hardware installed at the control point and tuned to a suitable frequency (e.g., 860 MHz-960 MHz). Reads from these passive tags (e.g., asset tags 12a) may be forwarded via network 20 to control software 18 and integrated with the active tag reads for logging purposes. In certain embodiments, one or more passive tag readers may be used to conduct scheduled and unscheduled asset audits. These passive tag readers may include handheld and/or fixed readers. Throughout this description, unless otherwise indicated, reference to activator 14 is meant to include either an activator or a reader.

System 10 may include one or more receivers 16. Each receiver 16 may be a transmission control protocol (TCP)/Internet Protocol (IP)-compatible network appliance that detects signals (e.g., that include tag information) sent from tags 12 located inside all entering or exiting cases and escort personnel. In certain embodiments, receiver 16 is an Axcess ActiveTag™ Network Receiver.

Receiver 16 is operable to receive tag information from tags 12. For example, receiver 16 is operable to receive tag information from asset tags 12a, asset aggregation tags 12b, and personnel tags 12c. The manner in which communication of the tag information from tags 12 to receiver 16 is initiated may vary, depending on the type of tag 12. For example, certain tags 12 may transmit tag information in response to a wake-up signal from activator 14. As another example, certain tags 12 may beacon tag information. The tag information received from a tag 12 may include one or more of a tag ID of the tag 12, an activator ID of the activator 14 that caused the tag 12 to communicate the tag information (if appropriate), timing information, sensor data, media data, and any other suitable information.

A portion or all of the tag information received by receiver 16 may be forwarded via network 20 to control software 18. In certain embodiments, signals transmitted by active tags 12 can be received at a distance of about thirty-five feet in a typical interior control point environment. Receivers 16 may be configured and controlled remotely via Hyper Terminal or commands issued from a software application program (e.g., control software 18). In certain embodiments, passive tags 12 may be read by a dedicated reader at approximately the same time as the active tags 12.

Tags 12 may communicate with activators 14 and/or receivers 16 over a link 22, which may include any suitable type of communication link (typically a wireless link) according to any suitable protocol and at any suitable frequency. In certain embodiments, link 22 is a radio frequency (RF) link.

Control software 18 may be operable to receive, process, and store data regarding tag reads from receivers 16. For example, receiver 16 may be operable to communicate a portion or all of the tag information received from tags 12 to control software 18 via network 20, and control software 18 is operable to receive, process, and store some or all of the tag information received from receiver 16. As just one example, control software 18 may be Axcess' e/OLS software; however, the present invention is not intended to be so limited.

Network 20 may include one or more local area networks (LANs), metropolitan area networks (MANs), wide area networks (WANs), radio access networks (RANs), a global computer network such as the Internet, or any other wireline, optical, wireless, or other links. Network 20 may communicate, for example, IP packets, Frame Relay frames, or Asynchronous Transfer Mode (ATM) cells to communicate voice, video, data, and other suitable information between network addresses.

Control software 18 may be stored and may execute on one or more computer systems comprising one or more processing modules and one or more memory modules. The one or more computer systems may be implemented as a mainframe or other stand alone computer, server, conventional desktop or laptop computer, or any other type of computing device. Each computer system may include one or more suitable input devices, output devices, mass storage media, processors, memory, or other components for receiving, processing, storing, and communicating information according to the operation of system 10. Furthermore, functionality described in connection with control software 18 may be provided using any suitable combination of software, firmware, and hardware.

The one or more processing modules of the one or more computer systems may include one or more processing units, which may include one or more microprocessors, controllers, or any other suitable computing devices or resources. The one or more processing modules may work either alone or in combination with other components of the one or more computer systems to provide the functionality of the one or more computer systems. For example, operations performed by the one or more processing modules may be performed collectively by the one or more processing modules and the one or more memory modules. Each memory module of the one or more computer systems may take the form of volatile or non-volatile memory including, without limitation, magnetic media, optical media, random access memory (RAM), read-only memory (ROM), removable media, or any other suitable memory component.

As described briefly above, control software 18 is operable to receive tag information from receivers 16. For example, control software 18 is operable to receive a portion or all of the tag information received by receivers 16 from asset tags 12a, asset aggregation tags 12b, and personnel tags 12c. Control software 18 may be operable to integrate the received tag information to track the asset tags 12a, asset aggregation tags 12b, and personnel tags 12c in association with one another. In a particular example, control software 18 may compare the received tag information for tags 12 to determine whether certain tags 12 are in substantially the same place at substantially the same time. Control software 18 may be operable to integrate passive and active tag reads for event-based logging, monitoring, alarming, and record-keeping. In certain embodiments, control software 18 features “function linkage” of assets and personnel that logically “links” single or multiple tags 12 associated with assets (e.g., asset tags 12a and asset aggregation tags 12b) to one or more personnel tags 12c.

It may be desirable for certain tags 12 to be linked together as a group. For example, it may be desirable to link together one or more asset tags 12a with one or more asset aggregation tags 12b, along with one or more personnel tags 12c. Returning to an example described above, a box may include a number of individual assets (e.g., products). Each of the individual assets may be tagged with an asset tag 12a, the box may be tagged with an asset aggregation tag 12b (the aggregation of assets being the collection of individual assets in the box), and an employee responsible for transporting the box of assets may be tagged with a personnel tag 12c. In this example, it may be desirable for the box to be linked to the assets in the box, as well as to the employee responsible for transporting the box. Therefore, it may be appropriate to link together the asset tags 20a associated with the assets in the box, the asset aggregation tag 12b associated with the box, and the personnel tag 12c associated with the employee. According to the other example described above, it may be appropriate for the trailer of the truck to be linked to the containers in the trailer and to the driver of the truck. Therefore, it may be appropriate to link together the asset tags 12a of the containers, the asset aggregation tag 12b associated with the trailer, and the personnel tag 12c associated with the driver of the truck.

The ability of control software 18 to integrate the tag information received from asset tags 12a, asset aggregation tags 12b, and personnel tags 12c may include processing the received tag information to draw any number of conclusions regarding linked tags 12 and to initiate any suitable action (e.g., generation of an alert) based on the conclusions. An example conclusion may include determining whether the linked tags 12 are at substantially the same location at substantially the same time. The association of these tags 12 may facilitate tracking of the assets and personnel tagged by these tags 12 in association with one another. For example, the association of these tags 12 may facilitate tracking of the assets and personnel tagged by these tags 12 as a collective unit that is functionally linked together.

Control software 18 may be operable to associate tag information for certain tags 12 with tag information for other tags 12, or to associate tags 12 with one another based on the tag information received. In certain embodiments, control software may access tag association information, which may specify associations among tags 12. For example, one or more asset tags 12a may be associated with one or more asset aggregation tags 12b and/or one or more personnel tags 12c. In a particular example, the one or more asset tags 12 are each associated with a carton of items in a vehicle, the one or more asset aggregation tags 12b are associated with the vehicle and the one or more asset tags, and the one or more personnel tags 12c are associated with a driver of the vehicle (and perhaps a passenger) along with the one or more asset tags 12a and asset aggregation tags 12b.

In certain embodiments, control software 18 is operable to analyze tag information received from receiver 16 according to the tag association information and to determine whether one or more alerts should be generated. For example, control software 18 may test one or more conditions based on the received tag information to determine if any alert should be issued. As a particular example, it may be important that a particular personnel tag 12c report the same location as particular asset tags 12a and/or asset aggregation tags 12b at a particular time (e.g., if the person associated with the personnel tag 12c is responsible for escorting the assets associated with asset tags 12a and/or asset aggregation tags 12b).

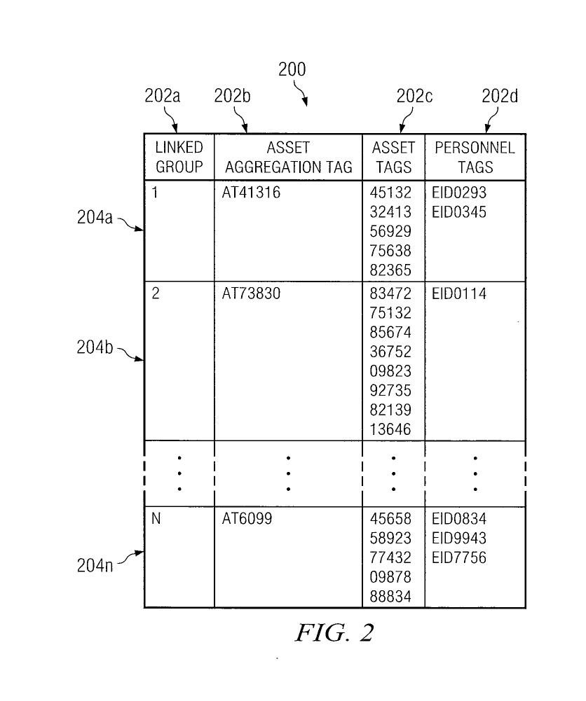

In certain embodiments, system 10 includes one or more databases 24. Databases 24 may include any suitable type of databases or other memory modules. In certain embodiments, databases 24 include structured query language (SQL) databases. Control software 18 may store the tag information received from receivers 16 in databases 24, along with any other suitable information, such as information generated by the processing of the tag information received from receivers 16 and data from other suitable systems. Databases 24 may store associations of tags 12 (e.g., tag association information). These associations may be thought of as links between tags 12. For example, databases 24 store one or more tables defining associations among tags 12. An example table that includes example tag association data is described in more detail below with reference to FIG. 2.

System 10 may include one or more sensor control systems 26, which may interface with control software 18. Control software 18 may provide an interface to one or more sensor control systems 26 through standard and custom or hardwire connections to provide system level integration of the sensors with the other identified system elements, alarms, and controls. Any of a number of sensor controls 26 may be integrated into system 10 as may be useful for management and control. Data from these sensors may be provided to control software 18 and integrated with the other information gathered by the system (such as data gathered from tags 12). The data from control software 18 may be provided to sensor control systems 26 and integrated with other information for action and control mechanisms. Management by exception may be automated, providing notification and sensor data and media streams of critical events that have occurred. In certain embodiments, control software 18 is operable to integrate with sensor control systems such as 26-bit Wiegand standard interface to most access control field panels.

In certain embodiments, some or all of tags 12 may include one or more sensors. These sensors may be any types of sensors, such as temperature sensors, motion sensors, gate/door sensors, chemical/biological sensors, GPS receivers, alarms, biometric scanning devices, and/or any other suitable sensors. As just two examples of sensors that may be associated with a tag 12, the sensors may include environmental sensors (e.g., temperature sensors, humidity sensors, etc.) and tamper sensors.

It will be understood throughout this description that any suitable device may operate as a sensor. For example, the above-described sensors may be independently associated with an asset or a tag of the asset and may transmit sensor data to control software 18. Additionally or alternatively, one or more multimedia devices may operate as a sensor. For example, a cellular telephone, personal digital assistant (PDA) (e.g., a BLACKBERRY), or other suitable multimedia processing device may provide sensor data. The sensor data may be the multimedia stream received from the multimedia processing device, may be included in the multimedia stream received from the processing device, or may be sent independently by the multimedia processing device.

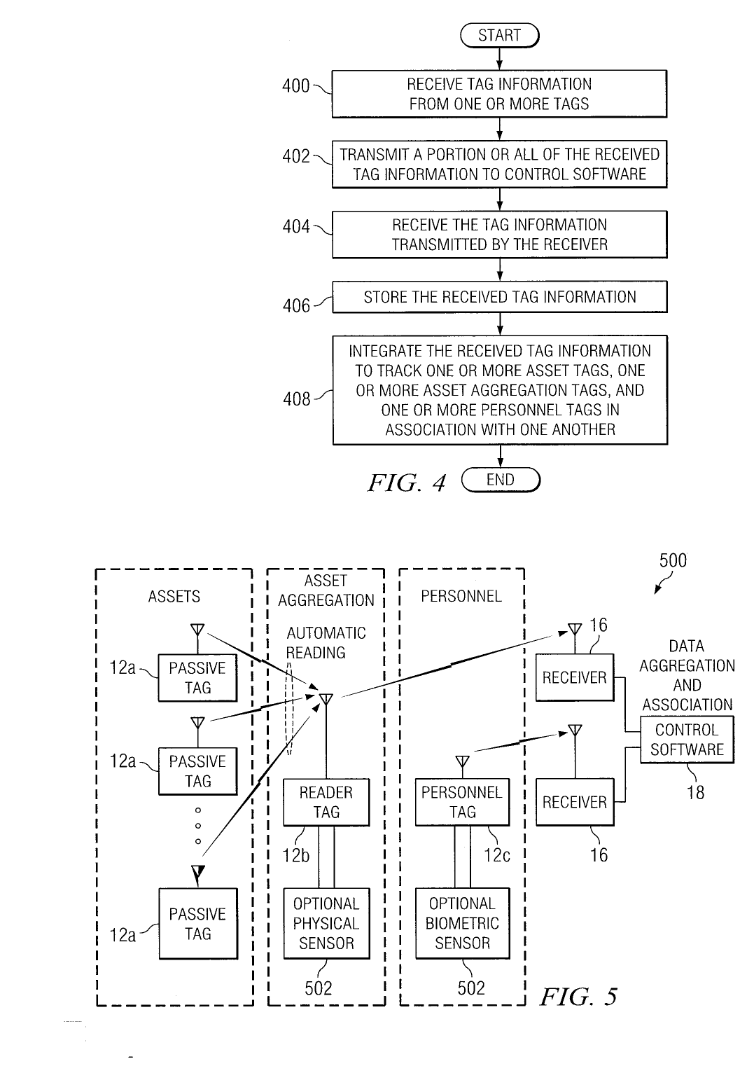

In certain embodiments, the tag information received by receiver 16 from tags 12 (and transmitted by receiver 16 to control software 18) may include sensor data determined by the one or more sensors of the tag 12. In certain embodiments, asset aggregation tags 12b may be operable to receive and process tag information from asset tags 12a, and to report this tag information (and/or conclusions determined from this tag information) to one or more receivers 16. This concept is described more fully below with reference to FIG. 5.

System 10 may include one or more media systems 28. Control software 18 may provide an interface to media systems 28 to provide system level integration of media systems 24 with the other identified system elements. Media systems 28 of any suitable types may be integrated into system 10 for key information and control of the product and data streams. Media streams may include, for example, video streams, voice streams, data streams, or any other suitable types of media streams. This provides control records and visual verification in the case of video media streams. Control software 18 may be operable to use media streams either local or remote to the designated area. The data provided by media systems 28 may allow managers or other personnel to visually monitor or use other media streams and supervise operations at their location using tag reads as personnel escorts enter and leave via a vehicle from the local facility. The media stream and controlling media system 28 may receive information from control software 18 and integrated that information with other information (e.g., received tag information) for action and control mechanisms. By integrating media systems 28 into an application, asset, container, and escort entry and exit activity review at any equipped location may further enhance system 10. Personnel (e.g., escort), container, and asset movement into and out of a facility can be verified with sensor data and media streams (e.g., digitally recorded video clips) and can be combined with the data received from tags 12 by an entry or exit event. Management by exception may be automated, providing notification and sensor data and media streams of critical events that have occurred. For example, when appropriate, one or more alerts may be generated via a cellular telephone, via e-mail (e.g., which could be received on an e-mail-capable PDA, such as a BLACKBERRY), or other suitable processing device.

As described above, in certain embodiments, one or more multimedia devices may be operable to transmit one or more of sensor information and media streams. This data may be received by control software 18. Control software may integrate at least a portion of the data received from the multimedia device with received tag information.

In certain embodiments, control software 18 is operable to integrate with other software management and control systems, such as via an SQL database or other database interface. Control software 18 may be operable to integrate with voice-over-IP (VoIP), material requirements planning (MRP)-Inventory, personnel systems, and any other suitable systems, sending relevant data to those systems for processing.

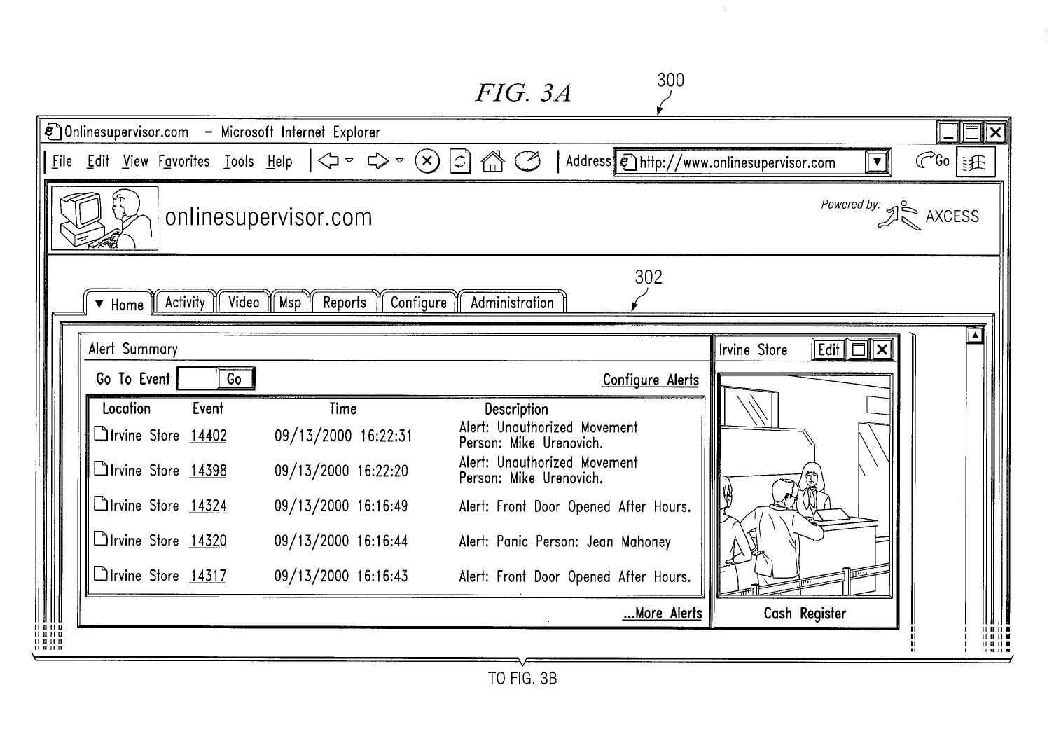

In certain embodiments, control software 18 provides one or more of the following management information: General Activity Information, Time & Attendance Information, Asset Status, Movement History, Functional Linkage Violations Information and Unauthorized Asset Movement Data. Control software 18 and other components of system 10 may interface via a 26-bit Wiegand standard interface to most access control field panels to control doors, gates, locks, and other sensor control systems 26 and their interfaces. An example screen shot that may be generated by control software 18 is described in more detail below with respect to FIGS. 3A-3B, which includes integrated network-based digital video as a component.

Particular embodiments of the present invention may provide one or more technical advantages. Particular embodiments of the present invention provide an integrated system 10 that includes one or more asset tags 12a, one or more asset aggregation tags 12b, one or more personnel tags 12c, control sensors (e.g., temperature sensors) and media streams (e.g., video and/or audio) that permits the automatic, independent and real time assessment of physical assets and personnel (along with desired control sensors and media streams). Different types of assets and/or personnel may be tagged with active or passive tags and linked together to provide for monitoring and control of the assets and/or personnel. Passive tags may be used on individual assets when a large number of such assets are being tracked, and aggregations of these individual assets (such as a box containing a number of the assets and a carton containing a number of these boxes) may be tagged with active tags (to more precisely track their location). Personnel may be tagged with active tags in particular embodiments to more precisely track their location. As used herein, the term “active tag” refers to either a fully active or semi-active tag.

Such embodiments may also provide validation in real time or as a matter of historical record in period transaction logs. This allows for product, data and personnel tracking from individual product, individual personnel, and data unit levels to any number of aggregated product, personnel and data units groups and provides a way to effectively and efficiently manage and control business or manufacturing activity. System 10 may also provide real-time monitoring, viewing, recording, and storage and may provide standard interfaces to other enterprise software systems for messaging and relaying (in real time and/or at later times) information useful for improved management systems.

Certain embodiments of the present invention may provide one or more of the following benefits: real-time knowledge of system and components; confirmed validation of elements in the system at a later time; reduced risk of loss or missing elements; an understanding of level of loss of elements at all times; integration and recording of personnel, assets and conditions; the ability to provide reporting to meet Sarbanes-Oxley certification requirements; improved business process flow and control; and/or real time intervention when alarms are issued.

Although embodiments of the present invention may use an integrated system of asset tags 12a, asset aggregation tags 12b, and personnel tags 12c, such as active and passive tags (as well as optional sensors and media streams) in a large number and variety of different applications, the following description provides various example implementations.

1. Tracking of Data Storage Tapes

In certain embodiments, the present invention may be used to track data storage tapes. These data storage tapes are often used to store sensitive data that should be kept secure. Typically, each tape is kept in its own case, and a number of these cases are kept in a larger case, often referred to as a “turtle case.”

In this example implementation, the assets being tracked may include data storage tapes (such as those used by financial institutions and other entities to store sensitive personal information). In addition, personnel interacting with the tapes may also be tracked. A financial institution, independent auditors or other data tape user can verify that the user is taking all possible actions to ensure the security of sensitive data on data tapes as they leave or enter its facilities. Reports can be generated to track these assets down to the cartridge level in real time or at a later time.

In certain embodiments, each tape (asset) has a passive or active tag (although if there are a large number of tapes, passive tags may be most economical). Each tape transport case may also have a passive or active tag (e.g., an asset aggregation tag 12b). Furthermore, each packing carton used to hold a number of tapes for transport may also have a passive or active tag (e.g., an asset aggregation tag 12b). The tracking of such tapes may be important since in typical situations each tape has a “recovery value” estimated at approximately $100 to approximately $1,000. Each person entering tape rooms may have a personnel tag 12c (e.g., an active tag). Furthermore, each tape room may have one or more control sensors such as a temperature sensor and may have one or more media streams (such as video monitoring).

A particular embodiment of such a system employs Axcess Inc.'s ActiveTag™ personnel tags, asset tags combined with Axcess' “control point” reader and associated wake-up technology installed at the designated tape data center entry/exit point. Each of the data tapes may be outfitted with a passive RFID label (tag) (e.g., an asset tag 12a) designed to be read individually or in combination with multiple tapes collected in a commercially available transport case. In certain embodiments, these asset tags 12a may be EPCglobal™ standard compliant for the selected Class 0, 1, or 2 tags. Each transport case may be equipped with an Axcess asset aggregation tag 12b to ensure each case is properly identified and logged as it passes through the designated control point. Further, all personnel authorized to move tapes and transport cases in and out of the data center may be issued an Axcess personnel tag 12c. All of the tapes, cases, and escort tags may be “functionally linked” in the control software 18 (e.g., Axcess' e/OLS software application module) to ensure that tapes are moving in and out of the facility only with authorized personnel. Cartridges moving through the designated data center control point without an authorized escort will cause a real-time software alert to be issued (e.g., which may be initiated by control software 18).

In particular embodiments, each tag 12 may respond to the activation field wake-up signal with a 315 MHz omni-directional transmission containing both the unique identification number of and door location ID. As each tape tag passes through the designated control point, it will respond to its wake-up field signal and report its unique ID to its reader located in the area. Readers/antennas for tags 12 may be installed at the designated control point to wake-up and collect tag ID and location information. The collected tag information may be forwarded via network 20 (e.g., an on-site LAN) to a computer running control software 18 (e.g., Axcess' e/OLS), which then combines the passive and active data streams for update of database 22. Authorized personnel may be provided log-on and password access to database 22 to view tag, case, and escort information as well as alerts due to unauthorized tape movement.

2. Tracking of Pharmaceutical Products

In this example, expensive or other highly controlled drugs may be tracked. For example, depending on the value of the individual drug unit (e.g., pills), each such individual drug unit may have no tag 12 or a passive tag 12. Furthermore, each pill bottle or other drug container may have a passive or an active tag 12. Furthermore, one or more boxes containing the pill bottles may have a passive or active tag 12 (and if these boxes are further aggregated into a carton, then such cartons may also have a passive or active tag 12). Each person entering a drug storage or distribution room has a personnel active tag 12c. In addition, each drug storage or distribution room may have one or more control sensors (such as temperature sensors) and may have one or more media streams (such as video monitoring). These tagged assets and personnel can be tracked and monitored in a similar way as described in the previous data tape example.

3. Controlled Site Key Storage, Distribution and Control

Many industries that provide monitored sites (ranging from casinos to manufacturing sites to government installations) use security keys in the process of securing these sites. Such keys are often used to ensure proper monitoring of a site by security guards. The guards carry these keys on security rounds and are required to insert these keys during specific time windows into alarm boxes to indicate that the associated area is clear and secure. Therefore, it is important to keep track of these keys (in many applications, if a key is lost then all keys must be destroyed and reissued). Therefore, another application of embodiments of the present invention is to tag these security keys (for example, with active tags 12) and to tag the security personnel with personnel tags 12c. In this way, as described in the data tape example above, these keys and their use by security personnel can be tracked.

4. Voice-Over-Internet-Protocol, Service Creation and Control

Certain embodiments of the present invention may allow for a remote service creation-and-control business from a remote network such as a VoIP server-based system to track assets and personnel (and monitor conditions and media streams) as a service creation business model to interested parties such as customer and vendor, manufacturer and shipper, warehouse facility and manufacturer, where providing data in substantially real time or at a later time is of great value in operational economies and control. Such systems may operate with devices such as mobile telephones, BLACKBERRIES, short message service (SMS) devices, or other suitable processing devices.

5. Interface to Industry Standard Data Sets and Data Protocols

In addition many industries have established data standards for sending and receiving data to optimize commerce. In certain embodiments, the present invention allows for interfacing with real time and at a later time data exchange with data standards. As just one example, the present invention may allow the interface via the 26-Wiegand standard which allows access to most control field panels to control doors, gates, locks, and such other access points. Such systems may operate with devices such as mobile telephones, BLACKBERRIES, short message service (SMS) devices, or other suitable processing devices.

6. Reporting and Tracking, for Cost and Billing for Service Transactions

In this example implementation, asset tags 12a and the personnel tags 12c (and or in additional sensors (such as number of times monitored) and or media streams (such as amount of time monitored)) are tracked for any metric that allows calculations and indexes to further assemble and track costs and billings. An implementation user, a service provider, a system operator or monitor, and/or individual system component supplier and/or user can establish and verify that any combination of metrics for the purposes of costing and billing for such normal business practices of internal cost allocations of services and/or external billings for service revenues and billings of any type. This could include the cost of service to maintain asset tags and or personnel tags. This could include billings for the number of times personnel entered or exited certain locations or number of asset tags moved over time. This could include costs and billings for the number sensor alerts or alarms. This could include the costs and billings for the amount of time media streams are running. This could include the costs and billings for the system operation and maintenance for costs and billings to individual and multiple parties to allocate costs and services and or to generate revenue from the costs and billings.

In addition to the above examples, there are a large number of other potential applications. Virtually any industry that tracks product (especially with respect to movement of the product by tagged personnel) can use a tracking system as described herein. Therefore, the above implementation examples are not meant to be limiting in any way.

FIG. 2 illustrates an example tag association table 200 that may be stored in database 22 of system 10. Tag association table 200 may store tag association information. Based on received tag information, control software 18 may access tag association table 200 to determine associations among tags 12, which may allow control software 18 to track certain tags 12 in association with one another and to draw certain conclusions regarding associated tags 12.

Table 200 includes a number of columns 202. Column 202a specifies a number for the linked group of tags. Column 202b identifies asset aggregation tags 12b using tag IDs for the asset aggregation tags 12b. Column 202c identifies asset tags 12a using tag IDs for the asset tags 12a. Column 202d identifies personnel tags 12c using tag IDs for the personnel tags 12c.

Table 200 includes a number of rows 204. Each row 204 corresponds to a linked group of tags 12. Table 200 may include any suitable number of linked groups. Each linked group of tags 12 may include zero or more asset tags 12a, zero or more asset aggregation tags 12b, and zero or more personnel tags 12c, in any suitable combination. As just one example, row 204a includes entries for linked group 1. Linked group 1 includes one asset aggregation tag 12b (AT41316), five asset tags 12a (45132, 32413, 56929, 75638, and 82365), and two personnel tags 12c (EID0293 and EID0345).

In operation of an example embodiment, control software 18 may receive from receiver 16 tag information for one or more asset tags 12a, one or more asset aggregation tags 12b, and/or one or more personnel tags 12c. Control software 18 may access table 200 to analyze the received tag information. For example the received tag information may include a number of tag IDs of the tags that generated the tag information. By accessing table 200, control software 18 may be able to determine whether all tags 12 of a particular linked group communicated tag information to receiver 16. If less than all tags 12 reported to receiver 16, it may be appropriate for control software 18 to initiate generation of an alert.

Table 200 illustrates just one example of a way to store information linking tags 12 together. The present invention contemplates any suitable technique to link or otherwise associate tags 12 together without departing from the spirit and scope of the present invention.

FIGS. 3A-3B illustrates an example display 300 that may be generated by control software 18 as part of the graphical user interface of control software 18. A user may interact with control software 18 using display 300. Display 300 may be just one of a number of displays that may be generated as part of the GUI of control software 18. Display 300 may allow a user to monitor tags 12, and thereby the assets and personnel associated with tags 12.

Display 300 includes a number of selectable tabs 302, which may allow a user to access particular functionality and information. In this example, tabs 302 include Home, Activity, Video, Map, Reports, Configure, and Administration. Each of these example features of display 300 is described in more detail below.

In the illustrated example display 300, the Home tab is currently selected. The Home page may display a critical information dashboard that includes personalized critical data in an easy to use “dashboard” format. Display 300 includes a number of example windows, as shown in the region marked 304 in FIGS. 3A-3B. One window provides personalized event notification, also referred to as alerts. Select predetermined, customized alert criteria for immediate notification via a suitable medium (e.g., email or pager). These alerts may be generated by on established alert rules. For example, alert rules may allow the user to track certain personnel or groups of personnel when entering or leaving the facility, or as they travel throughout the facility.

The Activity tab may display events detected based on the tag information received by control software 18 from receiver 16. In certain embodiments, selection of the Activity tab may cause a data stream to be displayed, the data stream including an event log listing a number of detected events. The event log may include one or more of the following: an indication of the tag ID (and/or information identifying the one or more assets or personnel associated with the tag), the location of the tag, the directionality of the tag (and/or some indication of the movement of the tag, such as IN or OUT), timing information, an indication of the activator 14 and/or receiver 16, and any other suitable information.

The Video tab, when selected, may allow a user to view one or more video streams from one or more sources. For example, control software 18 may receive video streams from one or more monitored locations. These video streams may be viewable by selecting the Video tab. A user may be able to see selected tracking information in association with actual video. For example, a user may be able to see a tagged assets cross a control point according to both tracking information indicating that the tagged assets are crossing the control point and a video stream of the tagged assets crossing the control point. As one particular example, system 10 may provide integration with media streams such as Axcess' Prism Video digital video and others.

The Map tab may allow a user to establish one or more location maps. For example, the user may be able to set up a map of a facility and locate where specific personnel and assets are within the facility, track activities of personnel during specified time intervals provided additional activation fields and receivers other than the gate areas are installed.

The Reports tab may provide the ability to generate one or more reports. In certain embodiments, control software 18 may be able to generate one or more reports based on an analysis of tag information received from receivers 16. Selection of the Reports tab may allow a user to view one or more reports. The reports may be generated based on the tag information (e.g., including personnel movement) with time date stamp.

The Configure tab may allow the user to establish the alert rules and other settings. In certain embodiments, selection of the Configure tab may display one or more screens that allow a user to change one or more settings associated with control software 14 and the monitoring of tags 12. As examples, the Configure tab may allow a user to establish which screens will be displayed in the dashboard screen of the Home tab or to establish queries and thresholds.

Among other administration features, the Administration tab may allow a user to establish multiple-level access security. For example, the user may be able to establish log-in name, password assignment, and group assignment levels to prevent lower-level personnel from accessing critical information.

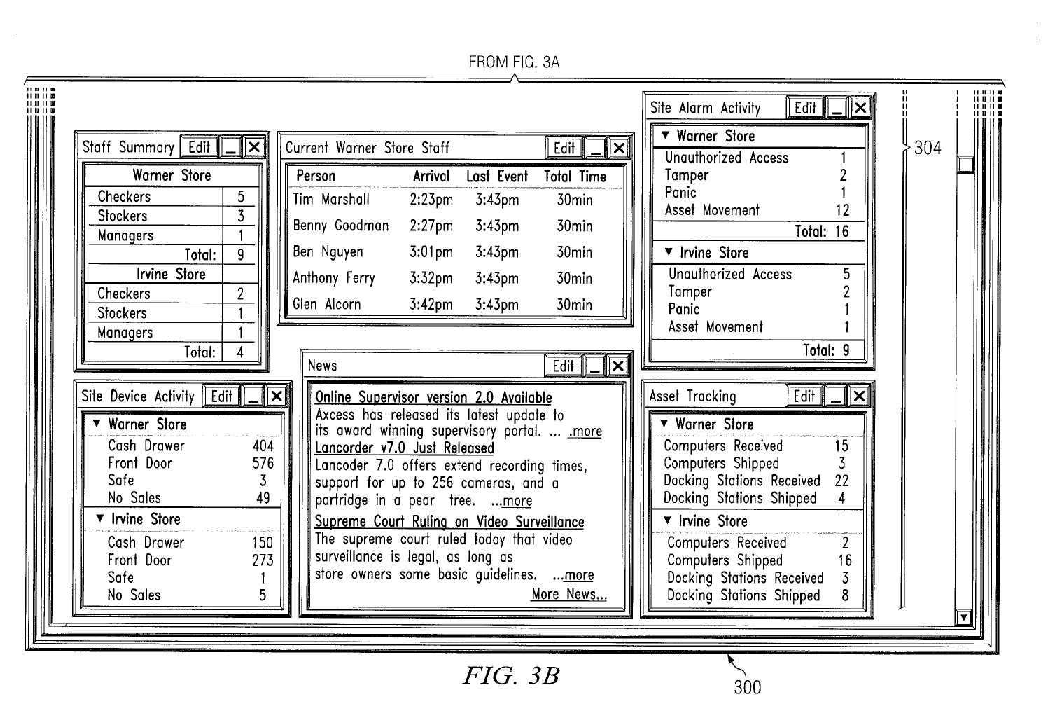

FIG. 4 illustrates an example method for multi-tag tracking, according to certain embodiments of the present invention. At step 400, receiver 16 receives tag information from one or more tags 12. For example, receiver 16 may receive tag information from one or more asset tags 12a, one or more asset aggregation tags 12b, and one or more personnel tags 12c. At step 402, receiver 16 may transmit a portion or all of the received tag information to control software 18. For example, receiver 16 may transmit the received tag information to control software 18 via network 20. Receiver 16 may transmit the tag information in response to a request from control software 18, or receiver 16 may transmit the tag information on its own at a suitable interval (which may include transmitting the tag information in substantially real time as it is received from tags 12).

At step 404, control software 18 may receive the tag information transmitted by receiver 16. For example, control software 18 may receive tag information for one or more asset tags 12a, one or more asset aggregation tags 12b, and one or more personnel tags 12c. At step 406, control software 18 may store the received tag information, in database 24 for example.

At step 408, control software 18 may integrate the received tag information to track the one or more asset tags 12a, one or more asset aggregation tags 12b, and one or more personnel tags 12c in association with one another. In a particular example, control software 18 may compare the received tag information for tags 12 to determine whether certain tags 12 are in substantially the same place at substantially the same time. Control software 18 may be operable to integrate passive and active tag reads for event-based logging, monitoring, alarming, and record-keeping. In certain embodiments, control software 18 features “function linkage” of assets and personnel that logically “links” single or multiple tags 12 associated with assets (e.g., asset tags 12a and asset aggregation tags 12b) to one or more personnel tags 12c.

As described above, certain tags 12 may be linked together as a group. For example, it may be desirable to link together one or more asset tags 12a with one or more asset aggregation tags 12b, along with one or more personnel tags 12c. The ability of control software 18 to integrate the tag information received from asset tags 12a, asset aggregation tags 12b, and personnel tags 12c may include processing the received tag information to draw any number of conclusions regarding linked tags 12 and to initiate any suitable action (e.g., generation of an alert) based on the conclusions. An example conclusion may include determining whether the linked tags 12 are at substantially the same location at substantially the same time. The association of these tags 12 may facilitate tracking of the assets and personnel tagged by these tags 12 in association with one another. For example, the association of these tags 12 may facilitate tracking of the assets and personnel tagged by these tags 12 as a collective unit that is functionally linked together.

Control software 18 may be operable to associate tag information for certain tags 12 with tag information for other tags 12, or to associate tags 12 with one another based on the tag information received. In certain embodiments, control software may access tag association information, which may specify associations among tags 12. For example, one or more asset tags 12a may be associated with one or more asset aggregation tags 12b and/or one or more personnel tags 12c.

In certain embodiments, control software 18 is operable to analyze tag information received from receiver 16 according to the tag association information and to determine whether one or more alerts should be generated. For example, control software 18 may test one or more conditions based on the received tag information to determine if any alert should be issued. As a particular example, it may be important that a particular personnel tag 12c report the same location as particular asset tags 12a and/or asset aggregation tags 12b at a particular time (e.g., if the person associated with the personnel tag 12c is responsible for escorting the assets associated with asset tags 12a and/or asset aggregation tags 12b).

In certain embodiments, control software 18 is operable to receive one or more of sensor data and media streams. Control software 18 may further integrate the sensor data and/or media streams with received tag information to further enhance monitoring of tagged assets and personnel. In an example in which a received media stream includes video, a user may be able to visually track tagged assets and personnel, in addition to receiving textual information describing the location or actions associated with the tagged assets and personnel, if appropriate.

FIG. 5 illustrates an example system 500 in which asset aggregation tags 12b are operable to receive and process tag information from asset tags 12a, and to report this tag information (and/or conclusions determined from this tag information) to one or more receivers 16. The functionality described with reference to system 500 may also be included in the capabilities of system 10, described above.

System 500 may provide the ability to associate (link) tags 12 by relative location. In certain embodiments, asset aggregation tags 12b may be operable to perform the functions of a tag reader, by automatically reading asset tags 12a and forwarding tag information received from the asset tags 12a (or information determined by asset aggregation tag 12b from the tag information received from the asset tags 12a) to one or more receivers 16. In particular embodiments, asset aggregation tags 12b comprise active tags and asset tags 12a comprise passive tags (e.g., EPC tags). These active asset aggregation tags 12b may transition to behave like a tag reader and automatically read the passive EPC asset tags 12a (e.g., automatically upon activation or when commanded to do so) within a locality defined by the proximity of the asset aggregation tag 12b. In certain embodiments, asset aggregation tag 12b may use an RF relay mechanism for generating the wake-up signals for energizing the passive asset tags 12a within the range of the asset aggregation tag 12b. Such an asset aggregation tag 12b may behave like a reader for a period of time, so as to capture and aggregate data from the passive asset tags 12a, and then the asset aggregation tag 12b may revert to operation as a normal backscatter tag to save power. Asset aggregation tag 12b may transmit a portion or all of the tag information gathered from asset tags 12a to receiver 16 (or directly to control software 18, if appropriate).

A particular example implementation may be the tape turtle case and individual tapes described above. An active asset aggregation tag 12b of the tape turtle case may operate as a reader for the passive asset tags 12a associated with the individual tapes. In the tape case example, each slot in the case may include a relay antenna (e.g., a conductive material at the base of the slots underneath each of the tapes) that is operable to read the passive asset tags 12a associated with the individual tapes relayed from the active asset aggregation tag 12b of the turtle case. The relay antenna may be wired back to the active asset aggregation tag 12b, which may be contact-less and operable to relay the burst signal (i.e., to energize the passive asset tags 12a) across the relay antenna. The passive asset tags 12a associated with the tapes may be coupled to the same link (i.e., the relay antenna). In certain embodiments, the passive asset tags 12a may be EPC-compliant tags, and the active asset aggregation tag 12b may be running the EPC protocol. At some interval, the active asset aggregation tag 12b may transmit a burst signal to energize and read the passive asset tags 12a. Based on the tag information received by the active asset aggregation tag 12b from the asset tags 12a in response to the burst signals, the active asset aggregation tag 12b may be able to determine whether any tapes are missing. For example, asset aggregation tag 12b may maintain a list tag IDs of asset tags 12a with which the asset aggregation tag 12b is linked. If a particular asset aggregation tag 12b does not receive tag information that includes a tag ID of a tag in the list, asset aggregation tag 12b may assume that the asset tag 12a (and possibly its associate asset) is either missing or has otherwise been tampered with. If a tape is determined to be missing, the active asset aggregation tag 12b may be operable to send an alert to a receiver 16 on behalf of the passive asset tag 12a.

Another example may be a trailer of containers that belongs to a tractor. The active asset aggregation tag 12b may be associated with the tractor and a passive asset tag 12a may be coupled to each container in the trailer. The burst signals generated by asset aggregation tag 12b may be RF relayed in a similar manner to that described above, but using a different power level if appropriate.

System 500 may provide association of tags 12 based on physical properties. In certain embodiments, a tag 12 may be associated with the asset or personnel to which the tag 12 is attached using one or more sensors 502. Sensors 502 may include capacitive sensors, chemical sensors, radiation sensors, biometric sensors, biometric scanning devices, or any other suitable types of sensors, according to particular needs. For example, a personnel tag 12c may locally associate with a particular person through biometric identification. As another example, asset tags 12a and asset aggregation tags 12b may be associated with certain properties of one or more assets (or their environment). As a particular example, an asset tag 12a may associate with the chemical, radiation, or electrical properties of a package (e.g., conductivity or acoustics of the package cavity when the package is full versus when the package is empty, or when carrying hazardous materials.)

In certain embodiments, an asset aggregation tag 12b may be able to query its associated asset tags 12a by sensor condition. For example, in response to a request from control software 18 or receiver 16, asset aggregation tag 12b may query a sensor condition of asset tags 12a. As another example, asset aggregation tag 12b may be configured to query the sensor condition of asset tags 12a at a suitable interval or on the occurrence of a particular event. Upon receiving the sensor condition from asset tags 12a, asset aggregation tag 12b may communicate the tag IDs of all asset tags 12a whose sensor data satisfies a particular condition. As just one example, the sensors may be temperature sensors, and asset aggregation tag 12b may return the tag IDs of all asset tags 12a whose sensor returns a temperature within a particular range.

Asset aggregation tag 12b may or may not maintain a list of its associated asset tags 12a. For example, suppose that the sensors are tamper-detection sensors. Asset aggregation tag 12b may simply query all tags to return a capacitance value. The query may simply be a signal to which all asset tags 12a within range will respond, and it may not be necessary for asset aggregation tag 12b to maintain a list of all of its associated asset tags 12a. Instead, asset aggregation tag 12b may simply raise an alert if a particular asset tag 12a returns an unacceptable capacitance value (which may indicate that the asset tag 12a has been tampered with). Additionally or alternatively, asset aggregation tag 12b may maintain a list of all asset tags 12 with which it is associated (i.e., linked), the list comprising the tag IDs of the associated asset tags 12a. Asset aggregation tag 12b may poll its associated asset tags 12a, receive tag information in response (which includes tag IDs for the responding asset tags 12a), and compare the received tag information to the stored list of tag IDs to determine if an asset tag 12a did not respond.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A tag tracking system, comprising:
one or more asset radio frequency identification (RFID) tags, each asset tag associated with an asset;
one or more asset aggregation RFID tags, each asset aggregation tag associated with an aggregation of assets;
one or more personnel RFID tags, each personnel tag associated with a person;
one or more receivers operable to receive tag information from the one or more asset tags, the one or more asset aggregation tags, and the one or more personnel tags; and
control software operable to:
receive at least a portion of the tag information from the one or more receivers; and
integrate the received tag information to track the one or more asset tags, one or more asset aggregation tags, and one or more personnel tags in association with one another.

2. The tracking system of claim 1, wherein the one or more asset tags are passive tags, the one or more asset aggregation tags are active tags, and the one or more personnel tags are active tags.

3. The tracking system of claim 1, wherein the control software is further operable to receive from one or more media sources one or more media streams associated with associated with one or more of the tags.

4. The tracking system of claim 3, wherein the one or more media streams comprise one or more of the following:
one or more video streams;
one or more voice streams; and
one or more data streams.

5. The tracking system of claim 1, wherein the control software is further operable to receive from one or more sensors information associated with one or more of the tags.

6. The tracking system of claim 1, wherein the control software is further operable to:
receive data from a multimedia device, the received data comprising one or more of a media stream and sensor information; and
integrating at least a portion of the data received from the multimedia device with the received tag information.

7. The tracking system of claim 1, wherein:
one or more of the asset tags are associated with an asset and a person; and
one or more of the asset aggregation tags are associated with an aggregation of assets and a person.

8. The tracking system of claim 1, wherein the control software is further operable to record and assemble the integrated tag information in a database for retrieval and future use.

9. The tracking system of claim 1, wherein the control software is operable to track the one or more asset tags, the one or more asset aggregation tags, and the one or more personnel tags in substantially real time using the integrated tag information.

10. The tracking system of claim 1, wherein the asset aggregation tag is operable to serve as a reader of the one or more asset tags by:
generating a wake-up signal for the one or more asset tags; and
receiving tag information from the one or more asset tags in response to the wake-up signal.

11. The tracking system of claim 10, wherein the asset aggregation tag is further operable to:
process the received tag information to determine whether one or more alerts should be generated; and
transmit, if it is determined that one or more alerts should be generated, an indication that one or more alerts should be generated.

12. The tracking system of claim 11, wherein the asset aggregation tag is operable to:
access a stored list of asset tags that are associated with the asset aggregation tag;
determine, in response to receiving the tag information from the one or more asset tags, whether any of the asset tags in the list of asset tags is missing.

13. The tracking system of claim 11, wherein:
each of the one or more asset aggregation tags comprises a sensor that is operable to monitor a condition; and
the asset aggregation tag is operable to:
query the one or more asset tags for a status of the condition monitored by the sensor of the tag; and
initiate generation of an alert if a certain condition is determined.

14. The tracking system of claim 1, wherein the tag information comprises one or more of the following:
a tag ID of the tag that generated the tag information;
an activator ID of an activator that caused the tag to transmit the tag information;
a sensor condition determined by a sensor of the tag; and
time and date information.

15. A method for tracking tags, comprising:
receiving tag information from one or more receivers, the one or more receivers having received the tag information from one or more asset radio frequency identification (RFID) tags, one or more asset aggregation RFID tags, and one or more personnel RFID tags, each asset tag associated with an asset, each asset aggregation tag associated with an aggregation of assets, and each personnel tag associated with a person; and
integrating the received tag information to track the one or more asset tags, one or more asset aggregation tags, and one or more personnel tags in association with one another.

16. The method of claim 15, wherein the one or more asset tags are passive tags, the one or more asset aggregation tags are active tags, and the one or more personnel tags are active tags.

17. The method of claim 15, further comprising receiving from one or more media sources one or more media streams associated with associated with one or more of the tags.

18. The method of claim 17, wherein the one or more media streams comprise one or more of the following:
one or more video streams;
one or more voice streams; and
one or more data streams.

19. The method of claim 15, further comprising receiving from one or more sensors information associated with one or more of the tags.

20. The method of claim 15, further comprising:
receiving data from a multimedia device, the received data comprising one or more of a media stream and sensor information; and
integrating at least a portion of the data received from the multimedia device with the received tag information.

21. The method of claim 15, wherein:
one or more of the asset tags are associated with an asset and a person; and
one or more of the asset aggregation tags are associated with an aggregation of assets and a person.

22. The method of claim 15, further comprising recording and assembling the integrated tag information in a database for retrieval and future use.

23. The method of claim 15, comprising tracking the one or more asset tags, the one or more asset aggregation tags, and the one or more personnel tags in substantially real time using the integrated tag information.

24. The method of claim 15, wherein the asset aggregation tag is operable to serve as a reader of the one or more asset tags by:
generating a wake-up signal for the one or more asset tags;
receiving tag information from the one or more asset tags in response to the wake-up signal.

25. The method of claim 20, wherein the asset aggregation tag is further operable to:
process the received tag information to determine whether one or more alerts should be generated;
transmit, if it is determined that one or more alerts should be generated, an indication that one or more alerts should be generated.

26. The method of claim 21, wherein the asset aggregation tag is operable to:
access a list of asset tags predetermined to be associated with the asset aggregation tag;
determine, in response to receiving the tag information from the one or more asset tags, whether any of the asset tags in the list of asset tags is missing.

27. The method of claim 21, wherein:
each of the one or more asset aggregation tags comprises a sensor that is operable to monitor a condition; and
the asset aggregation tag is operable to:
query the one or more asset tags for a status of the condition monitored by the sensor of the tag; and
initiate generation of an alert if a certain condition is determined.

28. The method of claim 15, wherein the tag information comprises one or more of the following:
a tag ID of the tag that generated the tag information;
an activator ID of an activator that caused the tag to transmit the tag information;
a sensor condition determined by a sensor of the tag; and
time and date information.

29. An asset aggregation tag for tracking one or more asset tags, comprising:
a power source; and
one or more processing units operable to transition to a tag reader state to:
transmit a query to one or more asset tags each having an associated sensor, the query requesting a sensor condition of the sensor of the asset tag;
receive, from each of the one or more asset tags, tag information comprising a sensor condition responsive to the query; and
transmit an indication of the sensor condition of at least one of the asset tags.

30. The asset aggregation tag of claim 29, wherein:
the asset aggregation tag comprises an active tag; and
the one or more asset tags each comprise a passive tag.

31. The asset aggregation tag of claim 29, operable to:
transition to the tag reader state from a state of operation as a tag; and
revert to the state of operation as a tag after receiving the tag information from the one or more asset tags.

32. The asset aggregation tag of claim 29, operable to transition to the tag reader state in response to a request initiated by control software.

33. The asset aggregation tag of claim 29, operable to transition to the tag reader state automatically according to a configuration of the asset aggregation tag.

34. The asset aggregation tag of claim 29, wherein the query was initiated by control software, the asset aggregation tag operable to receive the query.

35. The asset aggregation tag of claim 29, wherein the sensors of the one or more asset tags comprise one or more of the following:
a capacitive sensor;
a chemical sensors;
a radiation sensor;
a temperature sensor;
a biometric sensor; and
a biometric scanning device.

36. The asset aggregation tag of claim 29, wherein the sensor of at least one of the asset tags is associated with a multimedia device.
